(19) United States
(12) Patent Application Publication
(10) Pub. No.: US 2006/0202455 A1
(43) Pub. Date: Sep. 14, 2006

(54) Gas generator

(75) Inventors: Naoki Matsuda, Hyogo (JP); Nobuyuki Katsuda, Hyogo (JP); Haruhiko Yamashita, Hyogo (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/226,211

(22) Filed: Sep. 15, 2005

(30) Foreign Application Priority Data
Sep. 17, 2004 (JP) 2004-271723
Sep. 6, 2005 (JP) 2005-257690

(51) Int. Cl. B60R 21/26

(52) U.S. Cl. 280/736; 280/740

(57) ABSTRACT

The present invention provides a hybrid gas generator which is capable of keeping an air bag inflated by generating a lower-temperature gas so that the internal pressure of the air bag is maintained following inflation of the air bag. An opening serving as a gas outlet is formed in a cylindrical bottle 22 storing a pressurized medium, and the opening is sealed by a first sealing member 58 which is ruptured by an increase in the internal pressure of the bottle 22. The increase in the internal pressure of the bottle 22 is produced by activating heating means, and the temperature increase range of the pressurized medium before and after activation is not more than approximately 500° C.

### FIELD OF THE INVENTION

The present invention relates to a hybrid gas generator which is suitable for use in an air bag system installed in an automobile.

### BACKGROUND ARTS

A gas generator used to inflate an air bag preferably uses pressurized gas due to the cleanliness of the gas. Known examples of gas generators which use pressurized gas include a stored gas type gas generator in which pressurized gas alone is charged into the interior of a housing, and a hybrid gas generator which further employs a solid explosive. In both types of gas generator, a gas outlet opening is typically closed by a sealing plate in order to keep the pressurized medium sealed tightly, and the sealing plate is ruptured by rupturing means in order to discharge the gas. However, the hybrid gas generator is favorable in terms of the structure for rupturing the sealing plate and the structural simplicity of the entire gas generator itself.

More specifically, with a stored gas generator, in which there is no other option but to dispose the rupturing means in the vicinity of the rupturable plate, the rupturing means are disposed in the vicinity of the gas outlet, and hence a structure which avoids interference between the rupturing means and the air bag should be provided.

On the other hand, with a hybrid gas generator which also employs a solid explosive, the temperature of the pressurized medium is raised by combustion of the explosive, thereby raising the internal pressure of the housing so that the sealing plate is ruptured, and hence there are no restrictions on the positional relationship between the rupturing means, such as an igniter, and the gas outlet opening. This is one of the features of a hybrid gas generator.

JP-A No. 11-217054 exists as related background art. JP-A No. 11-217054 relates to a hybrid inflator, and states that “With respect to inflator temperature after activation thereof, it is desired that the temperature of inflation gases used to inflate the air/safety bag be sufficiently controlled or reduced to avoid potential erosion of certain metal parts including gas passageways within the inflator housing” and that “The inflation gas has a substantially lower temperature than the combustion gases”.

JP-A No. 11-217054 discloses a typical hybrid gas generator structure, but has no specific disclosure of the gas temperature and air bag inflatability.

### DISCLOSURE OF THE INVENTION

As described above, in a hybrid gas inflator, the temperature of the pressurized medium is raised by combustion of the explosive so that the internal pressure of the housing is increased, thereby causing the sealing plate to rupture. Therefore, although there are no restrictions on the positional relationship between the rupturing means and gas outlet opening, the internal pressure of the air bag decreases due to cooling of the inflation gas that is discharged to the exterior of the housing (i.e. the interior of the air bag). It is therefore difficult to use a hybrid gas generator in an air bag system in which the internal pressure of the air bag needs to be maintained for a certain time period following inflation.

It is therefore an aspect of the present invention to provide a hybrid gas generator which, while being a hybrid gas generator that uses an explosive, is capable of maintaining the internal pressure of an air bag following inflation of the bag by discharging lower-temperature gas from the gas generator. (i.e. by reducing temperature variation following gas discharge into the air bag), thereby keeping the air bag in an inflated state.

The invention provides a gas generator comprising an opening, serving as a gas outlet for discharging gas to the outside of a cylindrical bottle storing a pressurized medium, in the bottle, the opening being sealed by a first sealing member, the first sealing member being ruptured by an increase in the internal pressure of the bottle, the increase in the internal pressure of the bottle being produced by activating heating means including an explosive, the temperature-increasing range of the pressurized medium before and after activation of the gas generator being not more than approximately 500° C.

Further, the present invention provides a gas generator in which an opening serving as a gas outlet for discharging gas to the outside of a cylindrical bottle storing a pressurized medium is formed in one end portion of the bottle, the opening is sealed by a first sealing member, and the first sealing member is ruptured by an increase in the internal pressure of the bottle storing an explosive for heating the pressurized medium, and the increase in the inner pressure of the bottle is conducted by activation of a heating device including an explosives, wherein the explosive is ignited and burned, the temperature of the pressurized medium rises to at least a level corresponding to the pressure required for rupturing the first sealing member, and to a maximum temperature of approximately 500° C. higher than the temperature of the pressurized medium prior to activation of the gas generator.

The invention provides a gas generator comprising an opening, serving as a gas outlet for discharging gas to the outside of a cylindrical bottle storing a pressurized medium, in the bottle, the opening being sealed by a first sealing member, the first sealing member being ruptured by an increase in the internal pressure of the bottle, the increase in the internal pressure of the bottle being produced by activating heating means including an explosive, a difference between the temperature of the pressurized medium prior to activation of the gas generator and the temperature of the gas that is discharged through the opening in the cylindrical bottle following activation of the gas generator being not more than approximately 500° C.

The present invention described above is a gas generator which uses a pressurized medium and heating means (comprising an explosive) for heating the pressurized medium. An aspect of the present invention is to ensure that when gas for inflating an air bag is generated from the gas generator, the gas is supplied to the air bag at a temperature that has been reduced as far as possible. In so doing, temperature decrease of the gas can be reduced in the gas inside the air bag after discharging the gas into the interior of the air bag, and accordingly the decrease rate of the internal pressure of the air bag can be reduced, enabling reduced change in the air bag internal pressure. The air bag pressure is preferably maintained for at least six seconds after activation of the gas generator, and hence in this regards, conventionally, a pressurized gas (stored gas) type gas generator has been considered preferable for maintaining the internal pressure of the air bag following inflation. In the stored gas generator, however, the mechanism for opening the gas discharging port and the air bag attachment structure are complicated. In consideration of these points, the present invention has been based on a gas generator which raises the temperature of the pressurized medium using the combustion heat of an explosive.

The cross-section of the cylindrical bottle storing the pressurized medium is not limited to a circular form, and may take an elliptical or polygonal form. The gas outlet (opening portion) for discharging the gas to the outside thereof is formed in the cylindrical bottle, and prior to activation, the gas outlet (opening portion) is sealed by the first sealing member. The opening portion is preferably formed at one end portion of the cylindrical bottle, but is not limited to this location, and may be formed in the vicinity thereof (on a peripheral wall portion in the vicinity of the end portion of the bottle, for example).

There are no particular limitations on the explosive as long as it applies heat to the pressurized medium, and the explosive may generate an air bag-inflating gas as well as heat.

In the gas generator according to the present invention, at least one of the following items is adjusted within a range of not more than approximately 500° C., preferably not more than 400° C., and more preferably not more than 300° C. in order to limit as far as possible the reduction in the internal pressure of the air bag that is caused by the temperature reduction following gas discharge into the air bag:

(1) the temperature difference in the pressurized medium before and after activation of the gas generator (in other words, the temperature increase range);

(2) the difference between the temperature of the pressurized medium prior to activation of the gas generator, and the temperature of the gas that is discharged through the opening formed in the cylindrical bottle after activation of the gas generator;

(3) the temperature difference between the gas that is discharged from the gas generator and the outside air; and

(4) the temperature difference between the gas that is discharged into the air bag and the outside air.

By adjusting at least one of the above temperature differences (1) through (4) to not more than approximately 500° C., the gas generator is able to overcome temperature differences in the usage environment (climatic environment) and operate reliably, or in other words rupture the first sealing member reliably. Note that the temperature of the pressurized medium after activation of the gas generator in item (1) above is preferably measured in the vicinity of the opening formed in the cylindrical bottle.

The maximum output of the gas generator depends on the temperature and mol number of the generated gas, but when the generated gas does not leak out from the air bag (i.e. when the mol number of the gas that is discharged into the air bag does not change), the internal pressure of the bag decreases in accordance with decrease in the gas temperature. Hence, with gas generators having an equal output (maximum output), the output is preferably generated with the temperature of the generated gas (i.e. the increase in the temperature of the pressurized medium caused by the explosive) kept as low as possible and the mol number increased. Note, however, that in order to generate the internal pressure required to rupture the first rupturable plate in the interior of the gas generator, a temperature increase which at least corresponds to this pressure should be applied to the charged gas.

Even assuming that additional gas is generated from the explosive, heat always accompanies this additional gas, and hence when no gas leaks from the air bag as described above, maintenance of the air bag in an inflated state depends on the mol number of the pressurized gas that has been initially charged. Accordingly, the proportion of pressurized gas is preferably at least 87% of the entire generated gas mol number, and more preferably at least 90% thereof.

Moreover, in the gas generator of the present invention, in which the temperature increase range of the pressurized medium is adjusted as described above, the amount of gas that is discharged from the entire gas generator is preferably adjusted to between 1 and 4 mol, for example.

Furthermore, in the gas generator of the present invention, the heating means, including the explosive for heating the pressurized medium, are preferably disposed in a space that is partitioned from the pressurized medium in the bottle by a second sealing member prior to activation of the gas generator, and the second sealing member is preferably ruptured through activation of the heating means (in particular, ignition of the explosive). This hardly makes the explosive affected by the pressure of the pressurized medium, thus preventing deterioration in the performance of the explosive.

The heating means including the explosive may be disposed in the inside or outside of the bottle. For example, the heating means may be disposed in a chamber formed in the interior of the bottle by providing therein a partitioning member, a communication hole may be formed in the partitioning member, and the communication hole may be covered by the second rupturable plate. Alternatively, a housing storing the heating means may be disposed separately on the outside of the bottle, and a communication hole leading into the bottle may be sealed by the second rupturable plate.

Further, in the gas generator of the present invention, the heating means may include a gas generating agent which generates gas by combustion and ignition means which ignites and burns the gas generating agent, or it may include a gas generating agent which mainly generates heat by combustion and ignition means which ignites and burns the gas generating agent. The heating means constituted in this manner is preferably attached to an opposite end portion of the cylindrical bottle, in the axial direction thereof, to the end portion in which the opening serving as the gas outlet is formed. By means of this formation, the heating means (including the explosive) exists at one end portion of the bottle and the gas outlet exists at the other end portion of the bottle, and thus the gas flows from one end portion to the other end portion of the bottle. As a result, the temperature of the pressurized medium in the interior of the bottle can be raised evenly. Moreover, with this formation, the position of the heating means (including the explosive) is not limited only to the other end portion of the bottle, and the heating means may exist on a peripheral wall portion at the other end portion of the bottle, for example.

The heating means (including the explosive) includes the gas generating agent and the ignition means, and by producing further gas from the gas generating agent as well as heat, the internal pressure of the bottle can be increased more quickly. As a result, the sealing member can be ruptured at a lower temperature, and therefore a gas generating agent is preferably employed.

The ignition means includes an electric igniter which preferably ignites the gas generating agent directly, thus making the structure simple.

Further, in the gas generator of the present invention, a diffuser is preferably attached to the opening as the gas outlet, in which one end thereof is sealed and a plurality of gas discharge nozzles are formed evenly on a peripheral wall surface thereof. Moreover, then, in this case a cooling member for cooling the gas is preferably disposed in a gas passage connecting the gas discharge nozzles to a pressurized medium storage chamber.

A member for cooling the gas physically, such as a screen mede from various types of wire mesh, punched metal, lath metal, expanded metal, or compression-molded wire mesh, or a coolant which generates H₂O or the like by chemical decomposition or uses a chemical reaction generated through the absorption of generated heat, may be provided as the cooling member.

The gas passage provided with the cooling member is preferably a gas flow passage part existing on the outside (atmospheric pressure side) of the first sealing member, to be precise. This is to ensure that the internal pressure of the bottle is increased effectively by the temperature increase in the pressurized gas and that the first sealing member is ruptured reliably, and also due to the fact that after the first sealing member is ruptured, the temperature of the discharged gas would be preferably reduced as much as possible. Note that a screen is advantaged in that it not only cools the gas (the pressurized gas and the combustion gas generated by the gas generating agent) but also works to trap solid residue contained in the combustion gas generated by the gas generating agent.

Note that instead of providing the screen, the structure of the gas passage may be formed complicated so that the gas is cooled through frequent impingement thereon.

According to the present invention, the temperature of discharge gas can be reduced, and hence a decrease in the internal pressure of an air bag caused by a decrease in the temperature of the gas due to adiabatic expansion following discharge into the air bag can be suppressed, thereby ensuring that the pressure of the air bag varies little, and the internal pressure of the air bag can be maintained. Hence the present invention provides a gas generator that can be applied favorably to an air bag system such as a curtain air bag, in which the bag should be maintained in an inflated state for a certain period of time. Note that as long as the present invention is achieved, the temperature increase is not strictly limited to not more than 500° C.

### BRIEF DESCRIPTION OF THE DRAWING

FIG. 1 is an axial sectional view of an embodiment of a gas generator.

### DESCRIPTION OF REFERENCE NUMERALS

10 gas generator
20 pressurized gas chamber
22 pressurized gas chamber housing
30 gas generating chamber
32 gas generating chamber housing
34 ignition means
36 gas generating agent
38 communication hole
40 rupturable plate
42 gas discharge hole
44 cap
50 diffuser
52 gas discharge port
56 communication hole
58 rupturable plate

### EMBODIMENTS OF THE INVENTION

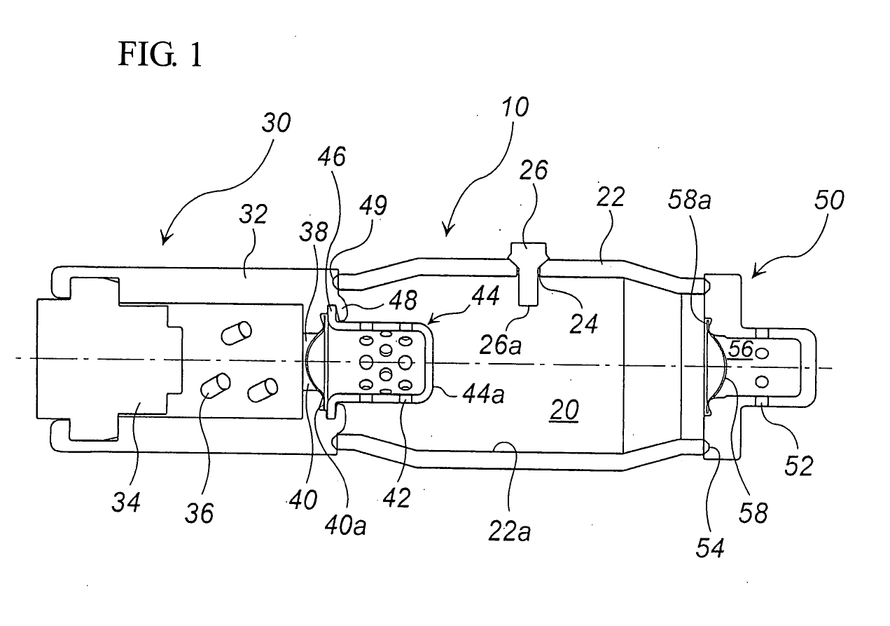

An embodiment of a gas generator according to the present invention will now be described using FIG. 1. FIG. 1 is an axial sectional view of the gas generator.

A gas generator 10 comprises a pressurized gas chamber 20, a gas generating chamber 30, and a diffuser portion 50.

The outer shell of the pressurized gas chamber 20 is formed by a cylindrical pressurized gas chamber housing (in other words, a cylindrical bottle) 22, and the pressurized gas chamber 20 is charged with a pressurized gas (in other words, a pressurized medium) including a single gas such as argon, helium, nitrogen, air, or carbon dioxide, or a mixture thereof. The pressurized gas chamber housing 22 is symmetrical in the axial and radial directions, and hence there is no need to adjust the orientation thereof in the axial and radial directions during assembly.

A pressurized gas charging hole 24 is formed on the side face of the pressurized gas chamber housing 22. The charging hole 24 is closed with a pin 26 after the pressurized gas has been charged.

The gas generating chamber 30 includes, as heating means, ignition means (an electric igniter) 34 and a gas generating agent 36, which are accommodated inside a gas generating chamber housing 32. The gas generating chamber 30 is connected to one end side of the pressurized gas chamber 20. The gas generating chamber housing 32 and pressurized gas chamber housing 22 are joined to each other at a joint portion 49 by resistance welding. When the gas generator 10 is incorporated into an air bag system, the ignition means 34 are connected to an external power source via a connector and wire.

A gas generating agent 36 can include, for example, nitroguanidine as a fuel, strontium nitrate as an oxidant, and sodium carboxymethyl cellulose as a bonding agent (having a combustion gas temperature between 700 and 1630° C.). The gas generating agent used in the present invention preferably generates 1.2 mols or more of combustion gas per 100 g, as does the gas generating agent described above. When the gas generating agent 36 having this composition is burned, the produced combustion residue is strontium oxide (melting point 2430° C.) Hence the combustion residue solidifies into lump form (slag form) without melting.

The pressurized gas chamber housing 22, gas generating chamber housing 32, and diffuser 50 are preferably formed from the same material.

A second through hole 38 between the pressurized gas chamber 20 and gas generating chamber 30 is sealed by a bowl-shaped second rupturable plate 40, and thus the interior of the gas generating chamber 30 is held at ambient pressure. The second rupturable plate 40 is joined to the gas generating chamber housing 32 at a peripheral edge portion 40a thereof by resistance welding.

A cap 44 having a gas discharge hole 42 is placed on the second rupturable plate 40 from the pressurized gas chamber 20 side. The cap 44 is attached to cover the second rupturable plate 40, thereby ensuring that the combustion gas generated by combustion of the gas generating agent 36 always passes through the cap 44 and is ejected through the gas discharge hole 42.

The cap 44 comprises a flange portion 46, an opening peripheral edge portion of which is bent outward, and the cap member 44 is fixed by crimping a portion (crimped portion) 48 of the gas generating chamber housing 32.

The diffuser portion 50, having gas discharge ports (in other words, gas discharge nozzles) 52 for discharging the pressurized gas and combustion gas is connected to the other end side of the pressurized gas chamber 20, and the diffuser portion 50 is joined to the pressurized gas chamber housing 22 at a joint portion 54 by resistance welding.

The diffuser portion 50 takes a cup form having the plurality of gas discharge holes 52 for transmitting the gas. Further, a cooling member (not shown) constituted by a filter or the like for cooling the gas in an arbitrary manner may be disposed on the inside opening of the diffuser portion 50.

A first communication hole (in other words, an opening) 56 between the pressurized gas chamber 20 and diffuser portion 50 is sealed by a first rupturable plate (in other words, a first sealing member) 58, and hence the interior of the diffuser portion 50 is held at ambient pressure. The first rupturable plate 58 is joined to the diffuser portion 50 at a peripheral edge portion 58a by resistance welding.

Next, an operation of the gas generator 10 shown in FIG. 1 when incorporated into an air bag system installed in an automobile will be described.

When the automobile receives an impact from a collision, the igniter 34 is activated and ignited by activation signal output means, whereby the gas generating agent 36 is burned, generating high-temperature combustion gas. At this time, the melting point of the combustion residue produced by combustion of the gas generating agent 36 is equal to or greater than the discharge temperature of the gas that is generated by the gas generating agent 36, and therefore the combustion residue does not melt easily and remains in a solid state.

The second rupturable plate (second sealing member) 40 is then ruptured by the increase in the internal pressure of the gas generating chamber 30 caused by the high-temperature combustion gas. Combustion gas including the combustion residue then flows into the cap 44 and is ejected through the gas discharge hole 42.

At this time, the combustion gas impinges on a closed end surface 44b of the cap 44, causing a change in the flow direction thereof so that the combustion gas flows out through the gas discharge hole 42.

The heat generated by the gas generating agent 36 is transmitted to the pressurized gas inside the pressurized gas chamber 20, causing the temperature of the pressurized gas to rise, which results in an increase in the internal pressure of the pressurized gas chamber 20. Furthermore, the high-temperature combustion residue is cooled and coagulated, and also adheres to the closed end surface 44b of the cap 44. The ejected combustion gas impinges on an internal wall 22a of the pressurized gas chamber housing 22, causing the combustion residue to adhere to the internal wall surface so that it cannot easily be discharged to the outside of the gas generator 10.

The first rupturable plate 58 is then ruptured by the increase in the internal pressure of the pressurized gas chamber 20, enabling the pressurized gas and combustion gas to pass through the first communication hole 56. The pressurized gas and combustion gas are then discharged through the gas discharge hole 52 to inflate the air bag.

The gas generator of the present invention may be applied as a gas generator for various types of air bag system other than a curtain air bag, such as an air bag system for a driver side, an air bag system for a front passenger side, an air bag system for a side air bag, and an air bag system for a knee bolster. The gas generator of the present invention may also be applied as a gas generator for an inflatable seatbelt, or as a gas generator for a pretensioner.

### EXAMPLE

A gas generator having the structure illustrated in FIG. 1 and the following characteristics was used in an air bag inflation experiment. This inflation experiment was performed to examine the internal pressure condition of an air bag, which is mounted to cover the gas discharge ports 52 in the diffuser portion 50, following activation of the gas generator (at an environmental temperature of 23° C.). More specifically, the internal pressure of the air bag was measured following the elapse of a fixed time period from an igniter activation timing of 0 msec. The results obtained in this inflation experiment are listed in Table 1.

Note that the air bag which was used is only formed with an opening in the part which connects to the diffuser 50.
Pressurized gas composition: Ar/He mixture
Solid gas generating agent composition: nitroguanidine/strontium nitrate/carboxymethyl cellulose
Pressurized gas charging amount: 1.27 mol
Number of mols of gas generated from gas generating agent: 0.13 mol
Total number of mols of gas generated from gas generator: 1.283 mol
Temperature of gas discharged from gas generator: 500° C.
Maximum output in tank having 1 ft³ (cubic feet) capacity: 220 kPa (at ambient temperature)

### COMPARATIVE EXAMPLE

A gas generator having the following characteristics was used to perform an identical experiment to that of the example.
Pressurized gas composition: Ar/He mixture
Solid gas generating agent composition: nitroguanidine/strontium nitrate/carboxymethyl cellulose
Pressurized gas charging amount: 0.84 mol (32.5 g)
Number of mols of gas generated from gas generating agent: 0.13 mol
Total number of mols of gas generated from gas generator: 0.97 mol
Temperature of gas discharged from gas generator: 750° C.
Maximum output in tank having 1 ft³ (cubic feet) capacity: 220 kPa (at ambient temperature)

As described above, the gas generators of the example and comparative example were connected to their respective air bags, and the internal pressure condition of the air bag after activation of the gas generator was examined (at an environmental temperature of 23° C.). Note that in both the example and comparative example, the material and volume of the employed air bag were identical, and the maximum pressure measured in the interior of the air bag was also substantially identical.

The results are listed in Table 1 below. Table 1 compares the internal pressure of the air bag in the example and comparative example following the elapse of a fixed time period from an igniter activation timing of 0 msec.

TABLE 1

| | Time after | | | | | | | | | | |
|---|---|---|---|---|---|---|---|---|---|---|---|
| | activation of | | | | | | | | | | |
| | igniter(msec) | | | | | | | | | | |
| | 100 | 200 | 400 | 800 | 1200 | 1600 | 2000 | 3000 | 4000 | 5000 | 6000 |
| Example(kPa) | 30.3 | 24.2 | 22.3 | 21.7 | 21.2 | 20.7 | 20.2 | 20.2 | 20.2 | 20.2 | 20.2 |
| Comparative | 23.3 | 18.2 | 15.2 | 12.2 | 11.6 | 11.1 | 10.6 | 9.1 | 8.6 | 8.1 | 7.6 |
| Example(kPa) | | | | | | | | | | | |

As is seen clearly from Table 1, although the maximum bag pressure (or the maximum output of the gas generator itself) is substantially identical in the example and comparative example, the internal pressure of the bag following activation is kept higher in the example, in which the discharge gas temperature is low. Alternatively, when seen in terms of the decrease rate of the air bag internal pressure from an initial period (100 msec, for example) following igniter activation, the example exhibits less variation.

Moreover, in the example, the internal pressure of the air bag exhibits substantially no reduction from 2000 msec following igniter activation onward. These results are attributable to the fact that the output of the gas generator in the example is dependent on the gas mol number, and therefore even if the pressurized gas temperature falls, the output of the gas generator (the internal pressure of the air bag) is little affected.

In contrast, the output of the gas generator in the comparative example is dependent on temperature increase, and therefore reductions in the gas temperature following discharge into the air bag greatly affect variation in the internal pressure of the air bag. This can also be seen from the fact that the ratio between the pressurized gas mol number and the amount of gas generating agent (the number of mols of gas generated by the gas generating agent) is varied in order to equalize the maximum output of the gas generators in the example and comparative example. As a result, with the gas generator of the example, the air bag remained inflated and maintained its passenger restraining capacity for a long time period, but with the comparative example, sufficient air bag internal pressure could not be obtained following activation, and the passenger restraining capacity was not satisfied.

In a typical hybrid type gas generator, a rapid temperature decrease occurs (the internal pressure of the bag decreases rapidly) at the moment the gas that is heated by the explosive is discharged into the air bag, and thereafter, the temperature decreases steadily. The present invention is not limited to a case in which substantially no internal pressure decrease can be seen within a fixed time period following igniter activation, as described in the example, and includes any case in which the internal pressure of the air bag can be maintained to a sufficient extent for passenger restraint or the like following the elapse of a fixed time period.

Note that the present invention is basically independent of the type of gas generating agent and pressurized gas, and is dependent solely on the degree of temperature increase following activation of the gas generator.

1. A gas generator comprising an opening, serving as a gas outlet for discharging gas to the outside of a cylindrical bottle storing a pressurized medium, in the bottle, the opening being sealed by a first sealing member, the first sealing member being ruptured by an increase in the internal pressure of the bottle, the increase in the internal pressure of the bottle being produced by activating heating means including an explosive, the temperature-increasing range of the pressurized medium before and after activation of the gas generator being not more than approximately 500° C.

2. A gas generator comprising an opening, serving as a gas outlet for discharging gas to the outside of a cylindrical bottle storing a pressurized medium, in the bottle, the opening being sealed by a first sealing member, the first sealing member being ruptured by an increase in the internal pressure of the bottle, the increase in the internal pressure of the bottle being produced by activating heating means including an explosive, a difference between the temperature of the pressurized medium prior to activation of the gas generator and the temperature of the gas that is discharged through the opening in the cylindrical bottle following activation of the gas generator being not more than approximately 500° C.

3. The gas generator according to claim 1 or 2, wherein the heating means are disposed in a space that is partitioned from the pressurized medium inside the bottle by a second sealing member prior to activation of the gas generator, and the second sealing member is ruptured through activation of the heating means.

4. The gas generator according to claim 1 or 2, wherein the opening serving as the gas discharging port is formed at one end portion of the cylindrical bottle in an axial direction thereof, the heating means includes a gas generating agent for generating gas through combustion and ignition means for igniting and burning the gas generating agent and the heating means are attached to an opposite end portion to the axial direction end portion side on which the opening is formed.

5. The gas generator according to claim 1 or 2, wherein a diffuser having one sealed end and a plurality of gas discharging nozzles formed evenly on a peripheral wall surface thereof is attached to the opening serving as the gas outlet, and a cooling member for cooling the gas is disposed in a gas passage connecting the gas discharge nozzles to a pressurized medium storage chamber.
